(19) United States
(12) Patent Application Publication
(10) Pub. No.: US 2026/0229239 A1
(43) Pub. Date: Aug. 6, 2026

(54) AUDIO SIGNAL CODING METHOD, AND DEVICE FOR CARRYING OUT SAME

(71) Applicant: ELECTRONICS AND TELECOMMUNICATIONS RESEARCH INSTITUTE, Daejeon (KR)

(72) Inventors: Byeongho CHO, Daejeon (KR); Seung Kwon BEACK, Daejeon (KR); Soo Young PARK, Daejeon (KR); Jongmo SUNG, Daejeon (KR); Woo-taek LIM, Daejeon (KR); Inseon JANG, Daejeon (KR)

(73) Assignee: ELECTRONICS AND TELECOMMUNICATIONS RESEARCH INSTITUTE, Daejeon (KR)

(21) Appl. No.: 19/147,528

(22) PCT Filed: Feb. 6, 2024
(86) PCT No.: PCT/KR2024/001678

§ 371 Date: Jul. 11, 2025

(30) Foreign Application Priority Data
Feb. 9, 2023 (KR) 10-2023-0017125
Jan. 19, 2024 (KR) 10-2024-0008946

(51) Int. Cl. G10L 19/032; G10L 19/26

(52) U.S. Cl. CPC G10L 19/032; G10L 19/26

(57) ABSTRACT

A method and device for coding an audio signal are provided. According to one embodiment, a method of decoding an audio signal includes receiving a bitstream including information about a first audio signal. The method includes generating a second audio signal based on first quantization information and a first frequency spectrum obtained from the bitstream. The first quantization information includes quantization information generated based on a first complex polynomial having complex linear prediction coefficients (LPCs) corresponding to the first audio signal as coefficients.

### TECHNICAL FIELD

The following description relates to a method and device for coding an audio signal.

### BACKGROUND ART

Linear prediction coding may be a core technique of a speech coding system and an audio coding system and has been developed in various types. The linear prediction coding may decrease an amount of information of a signal by using a filter that approximates human vocal tract with an all-pole model.

In the linear prediction coding, a predicted filter coefficient may be referred to as a linear predictive coefficient (LPC).

The above description is information the inventor(s) acquired during the course of conceiving the present disclosure, or already possessed at the time, and is not necessarily art publicly known before the present application was filed.

### DISCLOSURE OF THE INVENTION

### Technical Goals

One embodiment includes a method of effectively quantizing a polynomial having complex linear predictive coefficients (LPCs) as coefficients.

The technical goals to be achieved are not limited to those described above, and other technical goals not mentioned above are clearly understood by one of ordinary skill in the art from the following description.

### Technical Solutions

According to one embodiment, a method of decoding an audio signal includes receiving a bitstream including information about a first audio signal, and generating a second audio signal based on first quantization information and a first frequency spectrum obtained from the bitstream. The first quantization information includes quantization information generated based on a first complex polynomial having complex linear prediction coefficients (LPCs) corresponding to the first audio signal as coefficients.

The quantization information generated based on the first complex polynomial includes quantization information about solutions of a second complex polynomial and a third complex polynomial, which are generated based on the first complex polynomial.

The generating of the second audio signal includes filtering the first frequency spectrum based on the first quantization information to generate a second frequency spectrum. The generating of the second audio signal includes generating the second audio signal based on the second frequency spectrum.

Magnitudes of solutions of the second complex polynomial and the third complex polynomial are 1.

The second complex polynomial and the third complex polynomial are generated based on the first complex polynomial and a fourth complex polynomial.

The fourth complex polynomial is obtained based on a substitution operation on the first complex polynomial and a conjugate complex operation on the first complex polynomial to which the substitution operation is applied.

The second complex polynomial is generated based on a sum of the first complex polynomial and the fourth complex polynomial. The third complex polynomial is generated based on a difference of the first complex polynomial and the fourth complex polynomial.

The generating of the second audio signal based on the second frequency spectrum includes filtering the second frequency spectrum based on second quantization information obtained from the bitstream. The generating of the second audio signal based on the second frequency spectrum includes converting a filtered second frequency spectrum into a time domain signal to generate the second audio signal. The second quantization information includes quantization information about solutions of a fifth complex polynomial and solutions of a sixth complex polynomial. The fifth complex polynomial and the sixth complex polynomial are generated based on a seventh complex polynomial having real LPCs corresponding to the first audio signal as coefficients.

According to one embodiment, a method of encoding an audio signal includes generating a first frequency spectrum corresponding to an input audio signal. The method includes obtaining a first complex polynomial having complex LPCs corresponding to the first frequency spectrum as coefficients. The method includes generating a bitstream based on the first complex polynomial.

The generating of the bitstream includes obtaining a second complex polynomial and a third complex polynomial based on the first complex polynomial. The generating of the bitstream includes generating the bitstream based on solutions of the second complex polynomial and the third complex polynomial.

Magnitudes of the second complex polynomial and the third complex polynomial are 1.

The obtaining of the second complex polynomial and the third complex polynomial based on the first complex polynomial includes obtaining a fourth complex polynomial based on a substitution operation on the first complex polynomial and a conjugate complex operation on the first complex polynomial to which the substitution operation is applied. The obtaining of the second complex polynomial and the third complex polynomial based on the first complex polynomial includes obtaining the second complex polynomial and the third complex polynomial based on the first complex polynomial and the fourth complex polynomial.

The obtaining of the second complex polynomial and the third complex polynomial based on the first complex polynomial and the fourth complex polynomial includes obtaining the second complex polynomial based on a sum of the first complex polynomial and the fourth complex polynomial. The obtaining of the second complex polynomial and the third complex polynomial based on the first complex polynomial and the fourth complex polynomial includes obtaining the third complex polynomial based on a difference of the second complex polynomial and the fourth complex polynomial.

The generating of the bitstream based on the solutions of the second complex polynomial and the third complex polynomial includes reconstructing the complex LPCs based on phases of the solutions of the second complex polynomial and the third complex polynomial. The generating of the bitstream based on the solutions of the second complex polynomial and the third complex polynomial includes filtering the first frequency spectrum based on reconstructed complex LPCs. The generating of the bitstream based on the solutions of the second complex polynomial and the third complex polynomial includes generating the bitstream based on a filtered first frequency spectrum.

The reconstructing of the complex LPCs includes reconstructing the complex LPCs based on a quantization operation on the phases and an inverse quantization operation on quantized phases.

The generating of the first frequency spectrum includes generating a second frequency spectrum corresponding to the input audio signal. The generating of the first frequency spectrum includes filtering the second frequency spectrum based on real LPCs corresponding to the input audio signal to generate the first frequency spectrum.

According to one embodiment, a device for decoding an audio signal includes a processor and a memory configured to store instructions. When the instructions are executed by the processor, the device is configured to perform a plurality of operations. The plurality of operations includes receiving a bitstream including information about a first audio signal. The plurality of operations includes generating a second audio signal based on first quantization information and a first frequency spectrum obtained from the bitstream. The first quantization information includes quantization information generated based on a first complex polynomial having complex LPCs corresponding to the first audio signal as coefficients.

The quantization information generated based on the first complex polynomial includes quantization information about solutions of a second complex polynomial and a third complex polynomial, which are generated based on the first complex polynomial.

The generating of the second audio signal includes filtering the first frequency spectrum based on the first quantization information to generate a second frequency spectrum. The generating of the second audio signal includes generating the second audio signal based on the second frequency spectrum.

Magnitudes of solutions of the second complex polynomial and the third complex polynomial are 1.

The second complex polynomial and the third complex polynomial are generated based on the first complex polynomial and a fourth complex polynomial.

The fourth complex polynomial is obtained based on a substitution operation on the first complex polynomial and a conjugate complex operation on the first complex polynomial to which the substitution operation is applied.

The second complex polynomial is generated based on a sum of the first complex polynomial and the fourth complex polynomial. The third complex polynomial is generated based on a difference of the first complex polynomial and the fourth complex polynomial.

The generating of the second audio signal based on the second frequency spectrum includes filtering the second frequency spectrum based on second quantization information obtained from the bitstream. The generating of the second audio signal based on the second frequency spectrum includes converting a filtered second frequency spectrum into a time domain signal to generate the second audio signal. The second quantization information includes quantization information about solutions of a fifth complex polynomial and solutions of a sixth complex polynomial. The fifth complex polynomial and the sixth complex polynomial are generated based on a seventh complex polynomial having real LPCs corresponding to the first audio signal as coefficients.

According to one embodiment, a device for encoding an audio signal includes a processor and a memory configured to store instructions. When the instructions are executed by the processor, the device is configured to perform a plurality of operations. The plurality of operations includes generating a first frequency spectrum corresponding to an input audio signal. The plurality of operations includes obtaining a first complex polynomial having complex LPCs corresponding to the first frequency spectrum as coefficients. The plurality of operations includes generating a bitstream based on the first complex polynomial.

The generating of the bitstream includes obtaining a second complex polynomial and a third complex polynomial based on the first complex polynomial. The generating of the bitstream includes generating the bitstream based on solutions of the second complex polynomial and the third complex polynomial.

Magnitudes of the second complex polynomial and the third complex polynomial are 1.

The obtaining of the second complex polynomial and the third complex polynomial based on the first complex polynomial includes obtaining a fourth complex polynomial based on a substitution operation on the first complex polynomial and a conjugate complex operation on the first complex polynomial to which the substitution operation is applied. The obtaining of the second complex polynomial and the third complex polynomial based on the first complex polynomial includes obtaining the second complex polynomial and the third complex polynomial based on the first complex polynomial and the fourth complex polynomial.

The obtaining of the second complex polynomial and the third complex polynomial based on the first complex polynomial and the fourth complex polynomial includes obtaining the second complex polynomial based on a sum of the first complex polynomial and the fourth complex polynomial. The obtaining of the second complex polynomial and the third complex polynomial based on the first complex polynomial and the fourth complex polynomial includes obtaining the third complex polynomial based on a difference of the second complex polynomial and the fourth complex polynomial.

The generating of the bitstream based on the solutions of the second complex polynomial and the third complex polynomial includes reconstructing the complex LPCs based on phases of the solutions of the second complex polynomial and the third complex polynomial. The generating of the bitstream based on the solutions of the second complex polynomial and the third complex polynomial includes filtering the first frequency spectrum based on reconstructed complex LPCs. The generating of the bitstream based on the solutions of the second complex polynomial and the third complex polynomial includes generating the bitstream based on a filtered first frequency spectrum.

The reconstructing of the complex LPCs includes reconstructing the complex LPCs based on a quantization operation on the phases and an inverse quantization operation on quantized phases.

The generating of the first frequency spectrum includes generating a second frequency spectrum corresponding to the input audio signal. The generating of the first frequency spectrum includes filtering the second frequency spectrum based on real LPCs corresponding to the input audio signal to generate the first frequency spectrum.

According to one embodiment, a method of encoding an audio signal includes extracting a first complex LPC from an input audio signal. The method includes converting the first complex LPC into a real LPC using phase warping. The method includes coding the input audio signal based on the real LPC.

The extracting includes generating a frequency domain coefficient corresponding to the input audio signal. The extracting includes obtaining the first complex LPC from the frequency domain coefficient.

The converting includes warping phases of solutions of a first linear prediction system having the first complex LPC as a coefficient, such that the solutions are positioned on a first quadrant or a second quadrant. The converting includes calculating a second linear prediction system having phase warped solutions and complex conjugates of the phase warped solutions as solutions.

The warping includes decreasing the phase by half.

The coding includes calculating a line spectral frequency (LSF) corresponding to the real LPC. The coding includes coding the input audio signal using the LSF.

The coding of the input audio signal using the LSF includes calculating a residual signal using the LSF. The coding of the input audio signal using the LSF includes quantizing the residual signal. The coding of the input audio signal using the LSF includes coding a quantized residual signal.

The calculating of the residual signal using the LSF includes quantizing the LSF. The calculating of the residual signal using the LSF includes converting a quantized LSF into a second complex LPC. The calculating of the residual signal using the LSF includes calculating the residual signal using the second complex LPC.

According to one embodiment, a method of decoding an audio signal includes receiving a coded residual signal and a quantized LSF. The method includes converting the quantized LSF into a complex LPC using phase warping. The method includes outputting a time domain audio signal corresponding to the coded residual signal.

The converting includes converting the quantized LSF into an LSF through inverse quantization. The converting includes, among solutions of a first linear prediction system corresponding to the LSF, warping phases of the solutions on a first quadrant and a second quadrant. The converting includes calculating a second linear prediction system having the phase warped solutions as solutions. The converting includes extracting a coefficient of the second linear prediction system.

The warping includes extending the phase.

The outputting includes generating a quantized residual signal by decoding the coded residual signal. The outputting includes converting the quantized residual signal into a frequency domain residual signal through inverse quantization. The outputting includes generating a complex coefficient corresponding to the frequency domain residual signal by using the complex LPC. The outputting includes converting the complex coefficient into a time domain signal through an inverse Fourier transform.

According to one embodiment, a device for decoding an audio signal includes a processor and a memory configured to store instructions. When the instructions are executed by the processor, the device is configured to perform a plurality of operations. The plurality of operations includes extracting a first complex LPC from an input audio signal. The plurality of operations includes converting the first complex LPC into a real LPC using phase warping. The plurality of operations includes coding the input audio signal based on the real LPC.

The extracting includes generating a frequency domain coefficient corresponding to the input audio signal. The extracting includes obtaining the first complex LPC from the frequency domain coefficient.

The converting includes warping phases of solutions of a first linear prediction system having the first complex LPC as a coefficient, such that the solutions are positioned on a first quadrant or a second quadrant. The converting includes calculating a second linear prediction system having phase warped solutions and complex conjugates of the phase warped solutions as solutions.

The warping includes decreasing the phase.

The coding includes calculating an LSF corresponding to the real LPC. The coding includes coding the input audio signal using the LSF.

The coding of the input audio signal using the LSF includes calculating a residual signal using the LSF. The coding of the input audio signal using the LSF includes quantizing the residual signal. The coding of the input audio signal using the LSF includes coding a quantized residual signal.

The calculating of the residual signal using the LSF includes quantizing the LSF. The calculating of the residual signal using the LSF includes converting a quantized LSF into a second complex LPC. The calculating of the residual signal using the LSF includes calculating the residual signal using the second complex LPC.

According to one embodiment, a computer-readable storage medium storing one or more computer programs includes instructions to perform the method by the processor.

### BRIEF DESCRIPTION OF DRAWINGS

FIG. 1 is a diagram illustrating an encoder and a decoder according to one embodiment.

FIG. 2 is a diagram illustrating a first encoding process according to one embodiment.

FIGS. 3 to 5 are diagrams illustrating a phase warping preprocessing method according to one embodiment.

FIG. 6 is a diagram illustrating a first decoding process according to one embodiment.

FIG. 7 is a flowchart illustrating a first encoding process according to one embodiment.

FIG. 8 is a flowchart illustrating a first decoding process according to one embodiment.

FIG. 9 is a diagram illustrating a second encoding process according to one embodiment.

FIG. 10 is a diagram illustrating a second decoding process according to one embodiment.

FIG. 11 is a diagram illustrating a third encoding process according to one embodiment.

FIG. 12 is a diagram illustrating a third decoding process according to one embodiment.

FIG. 13 is a diagram illustrating an operation of a complex linear predictive coefficient (CLPC) analysis module according to one embodiment.

FIGS. 14 to 16 are diagrams illustrating an operation of a quantization module according to one embodiment.

FIG. 17 is a diagram illustrating an operation of an inverse quantization module according to one embodiment.

FIG. 18 is a schematic block diagram of an encoder according to one embodiment.

FIG. 19 is a schematic block diagram of a decoder according to one embodiment.

### BEST MODE FOR CARRYING OUT THE INVENTION

The following detailed structural or functional description is provided as an example only and various alterations and modifications may be made to the examples. Here, the examples are not construed as limited to the disclosure and should be understood to include all changes, equivalents, and replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a,” “an,” and “the” are intended to include the plural forms as well, unless the context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. It will be further understood that the terms “comprises/including” and/or “includes/including” when used herein, specify the presence of stated features, integers, operations, operations, elements, and/or components, but do not preclude the presence or addition of one or more other features, integers, operations, operations, elements, components and/or groups thereof.

Unless otherwise defined, all terms, including technical and scientific terms, used herein have the same meaning as commonly understood by one of ordinary skill in the art to which this disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

As used in connection with the present disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an example, the module may be implemented in a form of an application-specific integrated circuit (ASIC).

The term “unit” used herein may refer to a software or hardware component, such as a field-programmable gate array (FPGA) or an ASIC, and the “unit” performs predefined functions. However, “unit” is not limited to software or hardware. The “unit” may be configured to reside on an addressable storage medium or configured to operate one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, “unit” may include one or more processors.

Hereinafter, the embodiments will be described in detail with reference to the accompanying drawings. When describing the embodiments with reference to the accompanying drawings, like reference numerals refer to like elements and a repeated description related thereto will be omitted.

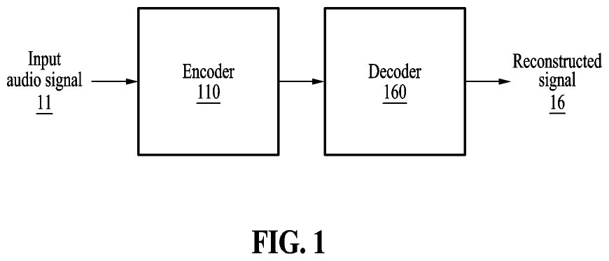

FIG. 1 is a diagram illustrating an encoder and a decoder according to one embodiment.

Referring to FIG. 1, according to one embodiment, an encoder 110 may generate a bitstream by encoding an input audio signal 11. The input audio signal 11 may include a speech signal. The input audio signal 11 may be a time domain signal having a real value.

A decoder 160 may generate a reconstructed signal 16 corresponding to the input audio signal 11 by using the bitstream generated by the encoder 110. The reconstructed signal 16 may be a time domain signal having a real value.

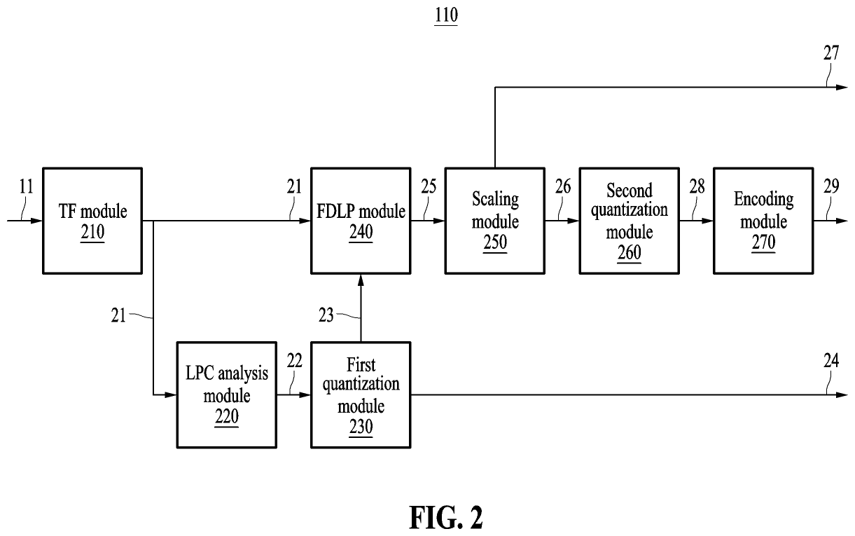

FIG. 2 is a diagram illustrating a first encoding process according to one embodiment.

Referring to FIG. 2, according to one embodiment, the encoder 110 may include a time-frequency (TF) module 210, a linear predictive coefficient (LPC) analysis module 220, a first quantization module 230, a frequency-domain linear prediction (FDLP) module 240, a scaling module 250, a second quantization module 260, and an encoding module 270.

The TF module 210 may generate frequency domain coefficients 21 corresponding to the input audio signal 11 by using a Fourier transform (e.g., a discrete Fourier transform). For example, the TF module 210 may generate the frequency domain coefficients 21 (e.g., complex coefficients) respectively corresponding to frames of the input audio signal 11.

The LPC analysis module 220 may generate first complex LPCs corresponding to the frequency domain coefficients 21 by analyzing the frequency domain coefficients 21.

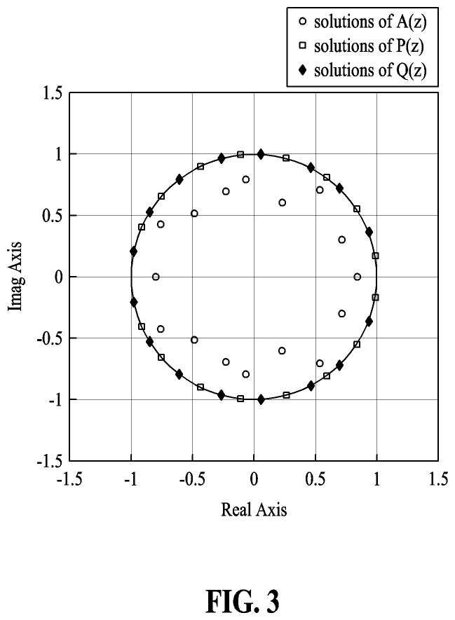

The first quantization module 230 may convert the first complex LPCs 22 into real LPCs, which are appropriate to quantization, based on a line spectral frequency (LSF). A method of converting first complex LPCs into real LPCs is further described with reference to FIGS. 3 to 5. The first quantization module 230 may obtain LSFs corresponding to real LPCs. The first quantization module 230 may quantize the LSFs.

The first quantization module 230 may convert quantized LSFs 24 into second complex LPCs 23. A process of converting the quantized LSFs 24 into the second complex LPCs 23 may be substantially the same as an inverse of a process of converting the first complex LPCs 22 into the quantized LSFs 24. Accordingly, a repeated description thereof is omitted. Since the second complex LPCs 23 are generated based on the quantized LSFs 24, the second complex LPCs 23 may be reconstructed first complex LPCs 22. The quantized LSFs 24 may be packed as a bitstream and the bitstream may be transmitted to a decoder (e.g., the decoder 160 of FIG. 1).

The FDLP module 240 may obtain a residual signal 25 corresponding to the frequency domain coefficient 21 by using the second complex LPCs 23. For example, the FDLP module 240 may obtain the residual signal 25 by filtering the frequency domain coefficient 21 based on the second complex LPCs 23.

The scaling module 250 may scale the residual signal 25. For example, the scaling module 250 may scale a magnitude of the residual signal 25. Scaling information 27 of the scaling module 250 may be included in a bitstream and the bitstream may be transmitted to the decoder 160. The scaling information 27 may include information about a scale factor.

The second quantization module 260 may quantize scaled magnitudes 26 of the residual signal 25 and phases 26 of the residual signal 25, respectively. The encoding module 270 may perform coding (e.g., lossless coding) on the quantized magnitudes 28 and the quantized phases 28. A coded signal (or a compressed signal) 29 may be packed as a bitstream and the bitstream may be transmitted to the decoder 160.

FIGS. 3 to 5 are diagrams illustrating a phase warping preprocessing method according to one embodiment.

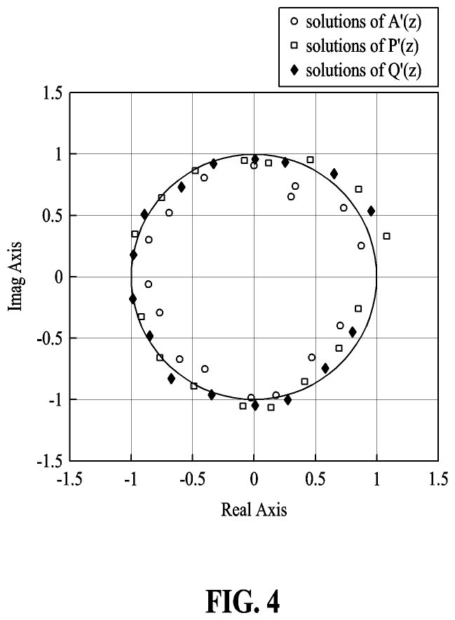

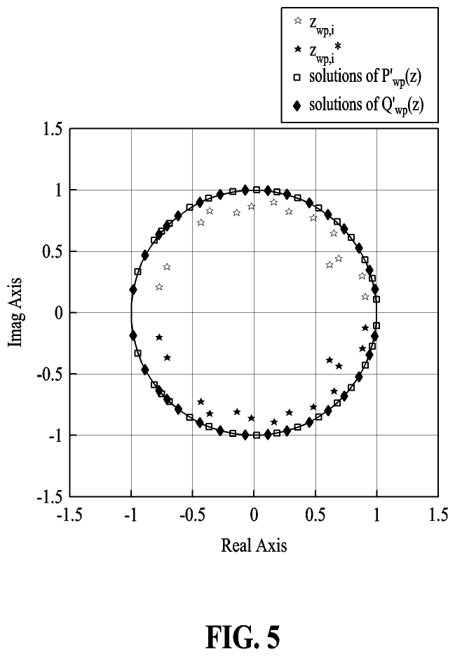

FIG. 3 may show positions of solutions of line spectral polynomials (LSPs) corresponding to a linear prediction system (e.g., a linear prediction filter) having real LPCs as coefficients. FIG. 4 may show positions of solutions of LSPs corresponding to a linear prediction system having complex LPCs as coefficients. FIG. 5 may show positions of solutions of LSPs corresponding to a linear prediction system having real LPCs as coefficients, wherein the real LPCs are generated based on phase warping.

Referring to FIG. 3, according to one embodiment, a linear prediction system calculated based on a time domain signal (e.g., the input audio signal 11 of FIG. 1) having a real value may be modeled as Equation 1 shown below.

$$A ( z ) = 1 - {\sum }_{l = 1}^{L} a ( l ) {z}^{- l} \qquad [ Equation 1 ]$$

In Equation 1, A(z) may denote a linear prediction system and a(l) may denote an l-th LPC.

Polynomials such as Equation 2 shown below may be obtained from Equation 1.

$${F}_{1} ( z ) = A ( z ) + {z}^{- ( L + 2 )} \cdot A ( {z}^{- 1} ) \qquad [ Equation 2 ]$$

$${F}_{2} ( z ) = A ( z ) - {z}^{- ( L + 1 )} A ( {z}^{- 1} )$$

In Equation 2, F₁(z) may denote a symmetric polynomial and F₂(z) may denote an antisymmetric polynomial.

Solutions of the polynomials F₁(z) and F₂(z) may be alternately positioned on a unit circle in a complex plane. Each of the polynomials may have L+1 solutions and each of the polynomials may have a real root (e.g., +1 or −1). By excluding the real root for critical sampling, polynomials (e.g., LSPs) may be obtained as Equation 3 shown below.

$$P ( z ) = \frac{{F}_{1} ( z )}{1 + {z}^{- 1}} and Q ( z ) = \frac{{F}_{2} ( z )}{1 - {z}^{- 1}} , L even , \qquad [ Equation 3 ]$$

$$P ( z ) = {F}_{1} ( z ) and Q ( z ) = \frac{{F}_{2} ( z )}{1 - {z}^{- 2}} , L odd ,$$

LSFs subject to quantization may be calculated by using Equation 3. As shown in FIG. 3, a solution of the linear prediction system A(z) having real LPCs as coefficients may be expressed as a pair of complex conjugates and solutions of LSPs P(z) and Q(z) corresponding to the linear prediction system A(z) may also be expressed as pairs of complex conjugates.

Referring to FIG. 4, according to one embodiment, LPCs corresponding to a complex-frequency domain coefficient may be complex LPCs. A solution of a linear prediction system A′(z) having complex LPCs as coefficients may not be expressed as a pair of complex conjugates.

The linear prediction system A′(z) may have L (e.g., 16) solutions. The solutions of the linear prediction system A′(z) may be positioned on a unit circle in a complex plane. In other words, magnitudes of the solutions of the linear prediction system A′(z) may be less than 1.

The solutions of the polynomials (e.g., complex line spectral polynomial (CLSP) P′(z) and Q′(z)) corresponding to the linear prediction system A′(z) may also not be positioned on the unit circle in the complex plane. In other words, the magnitudes of solutions of the polynomials (e.g., P′(z) and Q′(z)) corresponding to the linear prediction system A′(z) may have values other than 1.

It may be required to convert complex LPCs into real LPCs to apply LSF-based quantization. Phase warping based transformation may be applied to convert the complex LPCs into real LPCs, as shown below.

The solution of the linear prediction system A′(z) may be expressed as Equation 4.

$${A}^{′} ( {z}_{i} ) = 0 , \vert {z}_{i} \vert < 1 , i = 1 , 2 , … , L \qquad [ Equation 4 ]$$

An encoder (e.g., the encoder 110 of FIGS. 1 and 2) may warp phases of solutions zᵢ to position the solutions zᵢ of the linear prediction system A′(z) in a first quadrant or a second quadrant. For example, the encoder 110 may cause phase warped solutions z_{wp,i} to be positioned on the first quadrant or the second quadrant by decreasing phases of solutions zᵢ by half as Equation 5 shown below.

$${z}_{wp , i} = \vert {z}_{i} \vert * exp ( i * ∠ \frac{{z}_{i}}{2} ) \qquad [ Equation 5 ]$$

The encoder 110 may calculate a linear prediction system A_{wp}(z) having phase warped solutions z_{wp,i} and complex conjugates z_{wp,i}* of phase warped solutions z_{wp,i} as solutions. The solutions of the linear prediction system A_{wp}(z) may be expressed as a pair of complex conjugates and this may represent that the linear prediction system A_{wp}(z) has real LPCs as coefficients.

Referring to FIG. 5, according to one embodiment, respective solutions of LSPs P′_{wp}(z) and Q′_{wp}(z) corresponding to the linear prediction system A_{wp}(z) may have properties (e.g., interlaced properties) that solutions are alternately positioned on a unit circle in a complex plane. In other words, the encoder 110 may quantize phases (or phase information) of solutions of P′_{wp}(z) and Q′_{wp}(z) having phases between 0 and IT, based on LSF-based quantization. The quantized phase (e.g., quantized LSFs) may be packed as a bitstream and the bitstream may be transmitted to a decoder (e.g., the decoder 160 of FIG. 1).

Since a degree (e.g., 2L) of the linear prediction system A_{wp}(z) may increase twice a degree (e.g., L) of the linear prediction system A′(z), the degree of the corresponding LSFs may also increase twice. However, by considering that an information amount of a complex LPC is twice an information amount of a real LPC, an increase in the degree of LPC may not be problematic in an encoding aspect.

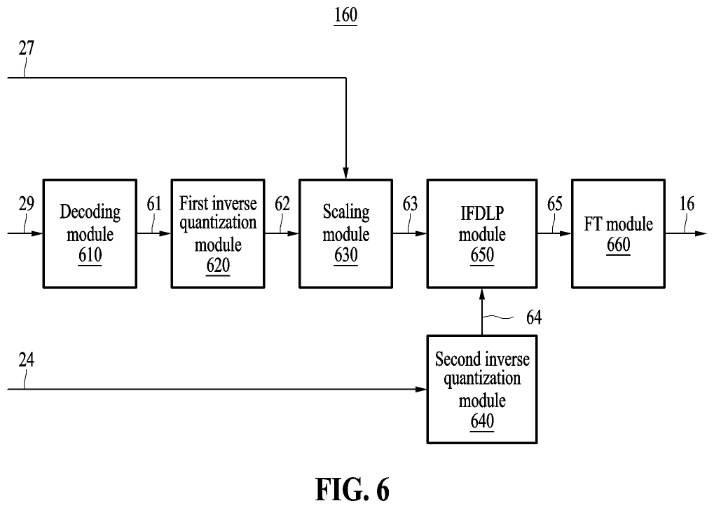

FIG. 6 is a diagram illustrating a first decoding process according to one embodiment.

Referring to FIG. 6, according to one embodiment, the decoder 160 may include a decoding module 610, a first inverse quantization module 620, a scaling module 630, a second inverse quantization module 640, an inverse frequency-domain linear prediction (IFDLP) module 650, and a frequency-time (FT) module 660. An operation performed by the decoder 160 may be the same as the reverse of an operation performed by an encoder (e.g., the encoder 110 of FIGS. 1 and 2). Accordingly, a detailed description thereof is omitted.

The decoding module 610 may obtain a coded signal 29 (e.g., a coded residual signal) from a bitstream received from an encoder (e.g., the encoder 110 of FIGS. 1 and 2). The decoding module 610 may generate a quantized signal 61 (or quantized information) (e.g., the quantized magnitude 28 and the quantized phase 28 of FIG. 2) by decoding (or reconstructing) the coded signal 29.

The first inverse quantization module 620 may inversely quantize the quantized signal 61 to generate information related to a residual signal 62 (e.g., the scaled magnitude 26 of the residual signal and the phase 26 of the residual signal of FIG. 2).

The scaling module 630 may scale (or descale) the residual signal 62 (e.g., the scaled magnitude 26 of the residual signal of FIG. 2) based on scaling information 27 received from the encoder 110.

The second inverse quantization module 640 may obtain quantized LSFs 24 from a bitstream received from the encoder 110. The second inverse quantization module 640 may convert the quantized LSFs 24 into complex LPCs based on phase warping. The second inverse quantization module 640 may inversely quantize the quantized LSFs 24 to obtain (or reconstruct) LSFs (e.g., LSFs generated by the first quantization module 230 of FIG. 2). The second inverse quantization module 640 may obtain solutions having a phase between 0 and π from the reconstructed LSFs. The second inverse quantization module 640 may obtain (or reconstruct) corresponding LSPs by increasing phases of obtained solutions by n times (e.g., n is a real number). The second inverse quantization module 640 may obtain (or reconstruct) complex LPCs 64 corresponding to the LSPs.

The IFDLP module 650 may convert the scaled (or descaled) residual signal 63 into a frequency domain coefficient 65 based on the complex LPCs 64. For example, the IFDLP module 650 may generate the frequency domain coefficient 65 by filtering the scaled residual signal 63 based on the complex LPCs 64.

The TF module 660 may generate a reconstructed signal 16 from the frequency domain coefficient 65 by using an inverse Fourier transform (e.g., an inverse discrete Fourier transform). The reconstructed signal 16 may be a time domain signal corresponding to an input audio signal (e.g., the input audio signal 11 of FIGS. 1 and 2).

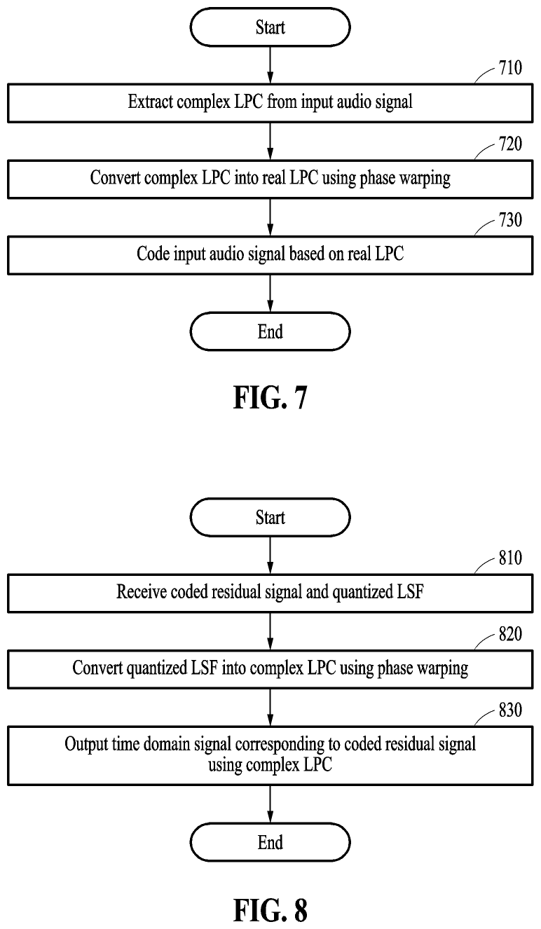

FIG. 7 is a flowchart illustrating a first encoding process according to one embodiment.

Referring to FIG. 7, according to one embodiment, a first encoding process (e.g., operations 710 to 730) may be substantially the same as operations of the encoder (e.g., the encoder 110 of FIGS. 1 and 2) described with reference to FIGS. 1 to 5. Accordingly, a repeated description thereof is omitted. Operations 710 to 730 may be performed sequentially, but examples are not limited thereto. For example, two or more operations may be performed in parallel.

In operation 710, the encoder 110 may extract complex LPCs (e.g., the first complex LPCs 22 of FIG. 2) from an input audio signal (e.g., the input audio signal 11 of FIGS. 1 and 2).

In operation 720, the encoder 110 may convert the complex LPCs 22 into real LPCs based on phase warping.

In operation 730, the encoder 110 may code (or compress) the input audio signal 11 based on the real LPCs.

According to one embodiment, the encoder 110 may provide a method of effectively quantizing the complex LPCs 22 by converting the complex LPCs 22 into real LPCs. For example, the encoder 110 may quantize LSFs corresponding to the complex LPCs 22 and may transmit the quantized LSFs to a decoder (e.g., the decoder 160 of FIGS. 1 and 6).

FIG. 8 is a flowchart illustrating a first decoding process according to one embodiment.

Referring to FIG. 8, according to one embodiment, a first decoding process (e.g., operations 810 to 830) may be substantially the same as operations of the decoder (e.g., the decoder 160 of FIGS. 1 and 6) described with reference to FIGS. 1 and 6. Accordingly, a repeated description thereof is omitted. Operations 810 to 830 may be performed sequentially, but examples are not limited thereto. For example, two or more operations may be performed in parallel.

In operation 810, the decoder 160 may receive a coded residual signal (e.g., the coded residual signal 29 of FIGS. 2 and 6) and quantized LSFs (e.g., the quantized LSFs 24 of FIGS. 2 and 6). The decoder 160 may receive a bitstream from an encoder (e.g., the encoder 110 of FIGS. 1 and 2). The bitstream may include the coded residual signal 29, the quantized LSF 24, and scaling information (e.g., the scaling information 27 of FIGS. 2 and 6).

In operation 820, the decoder 160 may convert the quantized LSFs 24 into complex LPCs (e.g., the complex LPCs 64 of FIG. 6) using phase warping.

In operation 830, the decoder 160 may output a time domain signal (e.g., the reconstructed signal 16 of FIGS. 1 and 6) corresponding to the coded residual signal 29 using the complex LPCs 64.

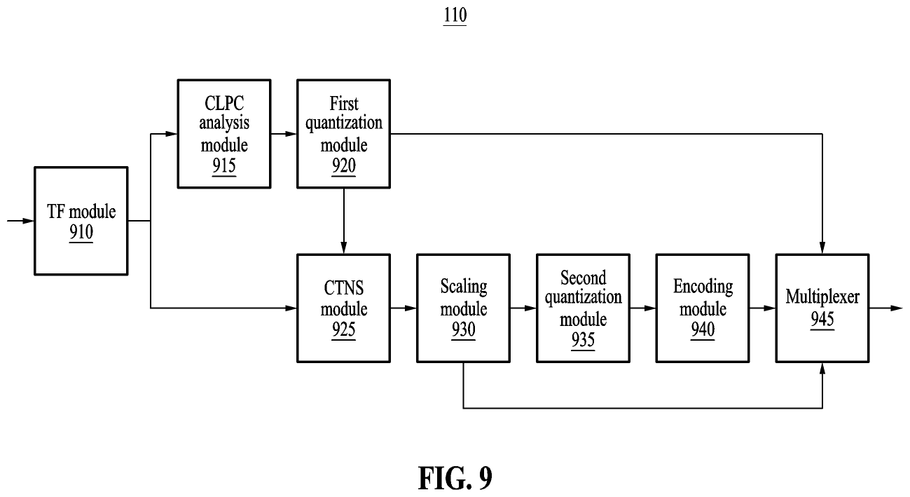

FIG. 9 is a diagram illustrating a second encoding process according to one embodiment.

Referring to FIG. 9, according to one embodiment, the encoder 110 may include a TF module 910, a complex LPC (CLPC) analysis module 915, a first quantization module 920, a complex temporal noise shaping (CTNS) module 925, a scaling module 930, a second quantization module 935, an encoding module 940, and a multiplexer 945.

The TF module 910 may obtain complex coefficients corresponding to frames of an input audio signal (e.g., the input audio signal 11 of FIG. 1). The TF module 910 may use transformation, such as a discrete Fourier transform (DFT) and a modulated complex lapped transform (MCLT), to obtain the complex coefficients.

The CLPC analysis module 915 may generate complex LPCs corresponding to the complex coefficients generated by the TF module 910. For example, the CLPC analysis module 915 may generate complex LPCs using the Levinson-Durbin algorithm. A linear prediction system A_{c}(z) (e.g., the linear prediction system A′(z) of Equation 4) having the complex LPCs as coefficients may be modeled by a complex polynomial as Equation 6.

$${A}_{c} ( z ) = 1 - {\sum }_{l = 1}^{L} {a}_{c} ( l ) {z}^{- l} \qquad [ Equation 6 ]$$

In Equation 6, a_{c}(I) may denote an l-th LPC.

Solutions (or zeros) of the linear prediction system A_{c}(z) may not be expressed as a pair of complex conjugates as described with reference to FIG. 4. As shown in FIG. 4, the solutions of the linear prediction system A_{c}(z) may be positioned on a unit circle in a complex plane. In other words, a magnitude of the solution of the linear prediction system A_{c}(z) may be less than 1.

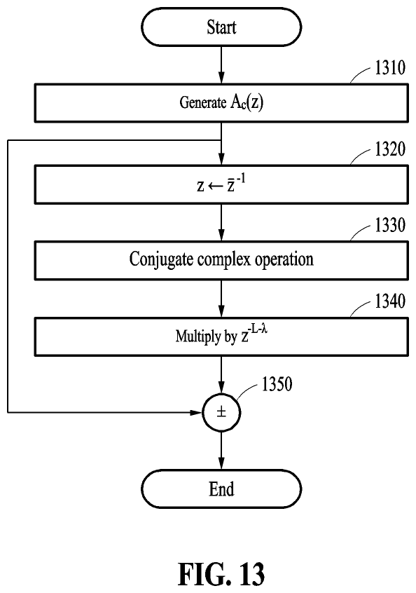

The CLPC analysis module 915 may obtain complex polynomials (e.g., CLSPs or complex immittance spectral polynomials (CISPs)) from the linear prediction system A_{c}(z). A method of obtaining complex polynomials from the linear prediction system A_{c}(z) is further described with reference to FIG. 13.

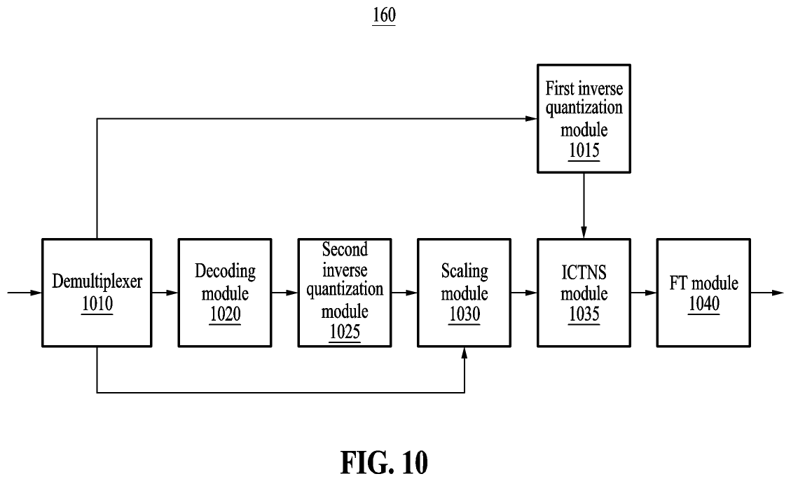

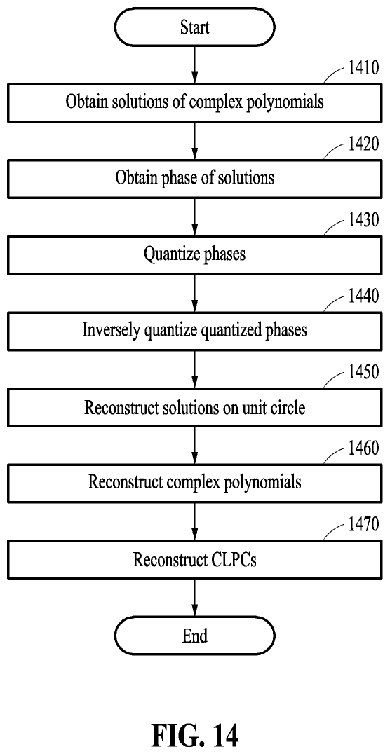

The first quantization module 920 may quantize information (e.g., phases of solutions, such as complex line spectral frequencies (CLSFs) or complex immittance spectral frequencies (CISFs)) about solutions of complex polynomials (e.g., CLSPs or CISPs) obtained by the CLPC analysis module 915. The quantized information may be packed as a bitstream and the bitstream may be transmitted to a decoder (e.g., the decoder 160 of FIG. 10). The first quantization module 920 may reconstruct the linear prediction system A_{c}(z) (or the complex LPCs) by using the quantized information. The operation of the first quantization module 920 is further described with reference to FIGS. 14 to 16.

The CTNS module 925 may generate a residual signal (e.g., a frequency spectrum) by filtering the complex coefficients generated by the TF module 910 based on the reconstructed linear prediction system A_{c}(z) (or reconstructed complex LPCs).

The scaling module 930 may scale the residual signal generated by the CTNS module 925. For example, the scaling module 930 may perform a scaling process on each of sub-bands based on a bitrate. Scaling information (e.g., a scale factor) of the scaling module 930 may be packed as a bitstream and the bitstream may be transmitted to a decoder (e.g., the decoder 160 of FIG. 10).

The second quantization module 935 may quantize the scaled residual signal in a complex domain.

The encoding module 940 may compress the quantized residual signal (e.g., complex quantization indices) generated by the second quantization module 935. For example, the encoding module 940 may use lossless coding (or lossless compression) to compress the quantized residual signal. The coded signal (or the compressed signal) may be packed as a bitstream and the bitstream may be transmitted to the decoder 160.

The multiplexer 945 may generate a bitstream based on quantized information (e.g., quantized CLSFs or quantized CISFs) by the first quantization module 920, scaling information of the scaling module 930, and a coded signal generated by the decoding module 940.

FIG. 10 is a diagram illustrating a second decoding process according to one embodiment.

Referring to FIG. 10, according to one embodiment, the decoder 160 may include a demultiplexer 1010, a first inverse quantization module 1015, a decoding module 1020, a second inverse quantization module 1025, a scaling module 1030, an inverse complex temporal noise shaping (ICTNS) module 1035, and an FT module 1040.

The demultiplexer 1010 may receive a bitstream from an encoder (e.g., the encoder 110 of FIG. 9). The demultiplexer 1010 may obtain a coded signal (or a compressed signal) (e.g., the coded signal generated by the encoding module 940 of FIG. 9), quantized information (e.g., quantized CLSFs or quantized CISFs generated by the first quantization module 920 of FIG. 9), and scaling information (e.g., the scaling information of the scaling module 930 of FIG. 9).

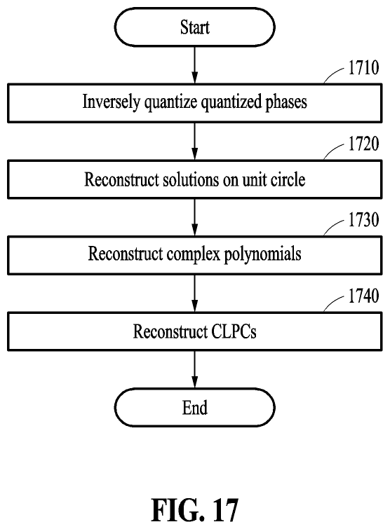

The first inverse quantization module 1015 may reconstruct the linear prediction system A_{c}(z) (or the complex LPCs) from the quantized information (e.g., the quantized CLSFs or the quantized CISFs) obtained by the demultiplexer 1010. The operation of the first inverse quantization module 1015 is further described with reference to FIG. 17.

The decoding module 1020 may perform the reverse of the operation performed by an encoding module (e.g., the encoding module 940 of FIG. 9) to reconstruct the quantized signal (e.g., the quantized signal by the second quantization module 935 of FIG. 9) from the coded signal obtained by the demultiplexer 1010. For example, the decoding module 1015 may generate (or reconstruct) the quantized signal based on lossless decoding.

The second inverse quantization module 1025 may generate (or reconstruct) a residual signal (e.g., a scaled residual signal generated by the scaling module 930 of FIG. 9) from the quantized signal obtained by the decoding module 1020. The second inverse quantization module 1025 may inversely quantize the quantized signal to generate a residual signal.

The scaling module 1030 stores the residual generated by the second inverse quantization module 1025 based on the scaling information obtained by the demultiplexer 1010 (e.g., the scaling information of the scaling module 930 in FIG. 9). Signals can be scaled. For example, when a scale factor is n (e.g., n is a natural number) of a scaling module (e.g., the scaling module 930 of FIG. 9), the scale factor of the scaling module 1030 may be 1/n. The scaling module 1030 may be perform a scaling process on each sub-band.

The ICTNS module 1035 may reconstruct complex coefficients (e.g., complex coefficients generated by the TF module 910 of FIG. 9) from the scaled residual signal generated by the scaling module 1030. The ICTNS module 1035 may perform the reverse of an operation performed by the CTNS module (e.g., the CTNS module 925 of FIG. 9) to reconstruct the complex coefficients.

The FT module 1040 may generate a reconstructed signal (e.g., the reconstructed signal 16 of FIG. 1) from the reconstructed complex coefficients generated by the ICTNS module 1035. The FT module 1040 may perform transformation, such as an inverse discrete Fourier transform (IDFT), a windowing operation, and/or an overlap operation to generate the reconstructed signal 16.

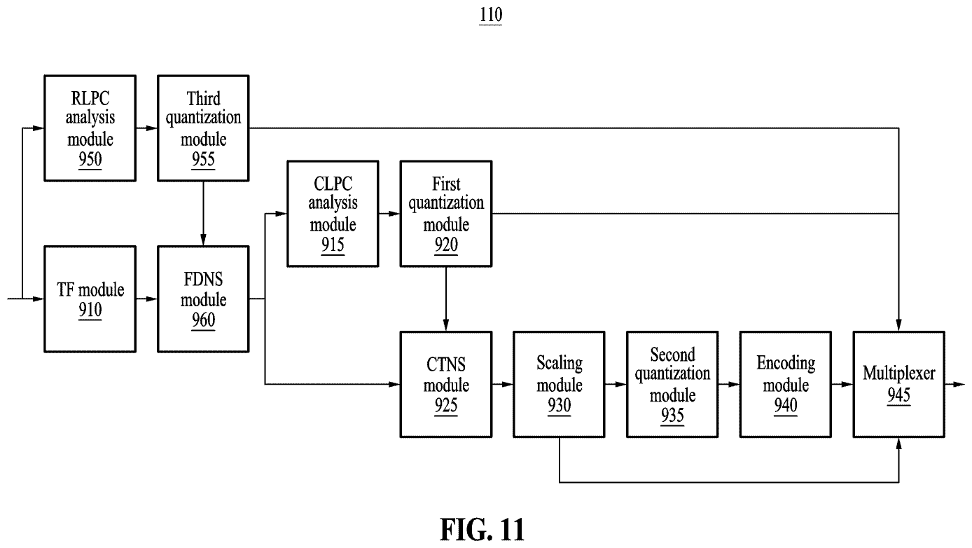

FIG. 11 is a diagram illustrating a third encoding process according to one embodiment.

Referring to FIG. 11, according to one embodiment, the encoder 110 may include the TF module 910, a real LPC (RLPC) analysis module 950, a third quantization module 955, a frequency domain noise shaping (FDNS) module 960, the CLPC analysis module 915, the first quantization module 920, the CTNS module 925, the scaling module 930, the second quantization module 935, the encoding module 940, and the multiplexer 945. The TF module 910, the CLPC analysis module 915, the first quantization module 920, the CTNS module 925, the scaling module 930, the second quantization module 935, the encoding module 940, and the multiplexer 945 may be substantially the same as the modules described with reference to FIG. 9. Accordingly, a repeated description thereof is omitted.

The RLPC analysis module 950 may generate real LPCs corresponding to an input audio signal (e.g., the input audio signal 11 of FIG. 1).

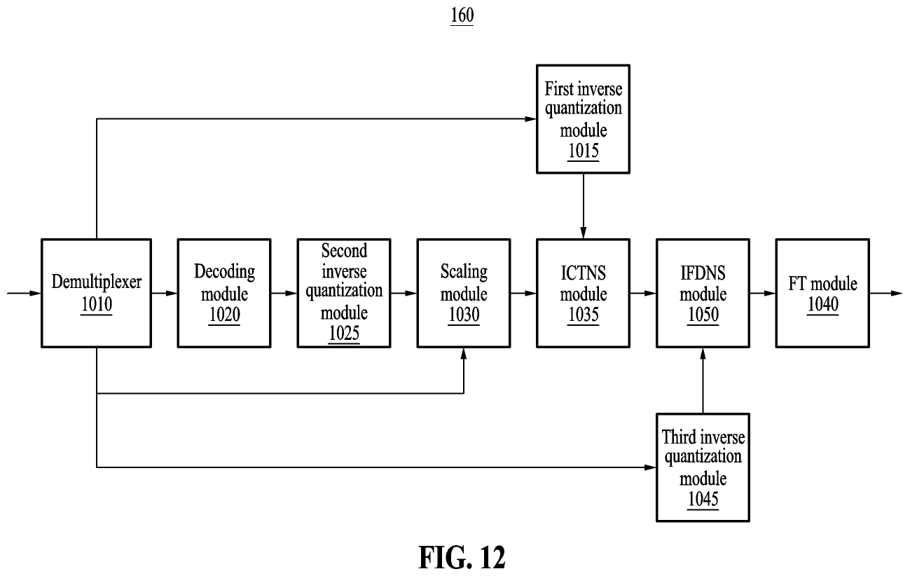

The third quantization module 955 may perform a quantization process and an inverse quantization process on the real LPCs generated by the RLPC analysis module 950 to generate reconstructed real LPCs. For example, the third quantization module 955 may obtain polynomials (e.g., P(z) and Q(z) of Equation 3) from a linear prediction system (e.g., the linear prediction system A(z) of FIG. 1) having real LPCs as coefficients, may quantize information (e.g., phases of solutions, such as LSFs and ISFs) about solutions of the obtained polynomials, and may inversely quantize the quantized information (e.g., the quantized LSFs or the quantized ISFs). The quantized information generated by the third quantization module 955 may be packed as a bitstream and the bitstream may be transmitted to a decoder (e.g., the decoder 160 of FIG. 12).

The FDNS module 960 may filter complex coefficients generated by the TF module 910 based on the reconstructed real LPCs generated by the third quantization module 955. The FNDS module 960 may reduce temporal redundancy.

FIG. 12 is a diagram illustrating a third decoding process according to one embodiment.

Referring to FIG. 12, according to one embodiment, the decoder 160 may include the demultiplexer 1010, the first inverse quantization module 1015, the decoding module 1020, the second inverse quantization module 1025, the scaling module 1030, the ICTNS module 1035, the FT module 1040, a third inverse quantization module 1045, and an inverse frequency-domain noise shaping (IFDNS) module 1050. The demultiplexer 1010, the first inverse quantization module 1015, the decoding module 1020, the second inverse quantization module 1025, the scaling module 1030, the ICTNS module 1035, and the FT module 1040 may be substantially the same as the modules described with reference to FIG. 10. Accordingly, a repeated description thereof is omitted.

The third inverse quantization module 1045 may inversely quantize quantized information (e.g., the quantized LSFs or the quantized ISFs generated by the third quantization module 955 of FIG. 11) obtained from the bitstream to reconstruct real LPCs (e.g., the real LPCs generated by the RLPC analysis module 950 of FIG. 11).

The IFDNS module 1050 may process the reconstructed frequency coefficients generated by the ICTNS module 1035 based on the reconstructed real LPCs generated by the third inverse quantization module 1045. The operation performed by the IFDNS module 1050 may be the same as the reverse of an operation performed by an FDNS module (e.g., the FDNS module 960 of FIG. 11).

FIG. 13 is a diagram illustrating an operation of a CLPC analysis module according to one embodiment.

Referring to FIG. 13, according to one embodiment, operations 1310 to 1350 may be sequentially performed but are not limited thereto. For example, two or more operations may be performed in parallel.

In operation 1310, the CLPC analysis module (e.g., the CLPC analysis module 915 of FIG. 9) may generate a linear prediction system (e.g., the linear prediction system A_{c}(z) of Equation 6) having complex LPCs as coefficients.

In operation 1320, the CLPC analysis module 915 may substitute Z of the linear prediction system A_{c}(z) with Z̅⁻¹.

In operation 1330, the CLPC analysis module 915 may apply a conjugate complex operation to the converted linear prediction system A_{c}(Z̅⁻¹).

In operation 1340, the CLPC analysis module 915 may generate a system polynomial Z^{-(L+λ)}A̅_̅{̅c̅}̅(̅Z̅⁻̅¹̅)̅ by multiplying a shifting operator Z^{-L-λ} by the linear prediction system A̅_̅{̅C̅}̅(̅Z̅⁻̅¹̅)̅ to which the conjugate complex operation is applied.

In operation 1350, the CLPC analysis module 915 may generate complex polynomials (e.g., CLSPs or CISPs), such as Equation 10, by adding or subtracting the system polynomial Z^{-(L+λ)} A̅_̅{̅C̅}̅(̅Z̅⁻̅¹̅)̅ to or from the linear prediction system A_{c}(z).

$${P}_{c} ( z ) = {A}_{c} ( z ) + {z}^{- ( L + λ )} \overline{{A}_{c} ( {\overline{z}}^{- 1} )} \qquad [ Equation 7 ]$$

$${Q}_{c} ( z ) = {A}_{c} ( z ) - {z}^{- ( L + λ )} \overline{{A}_{c} ( {\overline{z}}^{- 1} )}$$

In Equation 7, when λ is 1, P_{c}(Z) and Q_{c}(z) may be CLSPs and when λ is 0, P_{c}(Z) and Q_{c}(z) may be CISPs. However, λ may have a real value that is not 0 or 1.

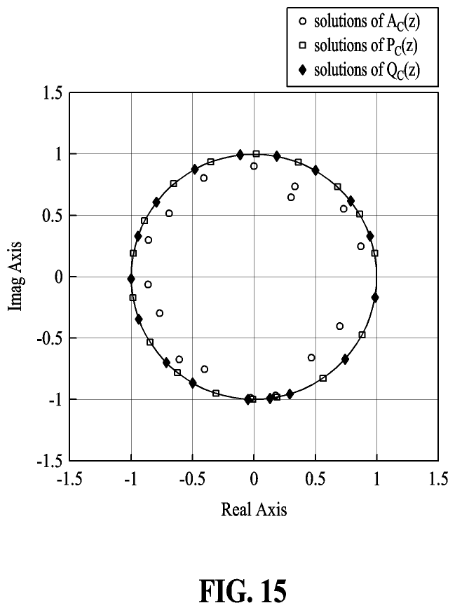

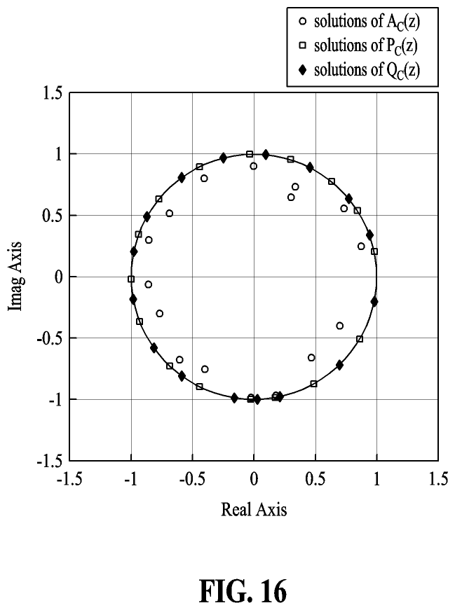

FIGS. 14 to 16 are diagrams illustrating an operation of a quantization module according to one embodiment. FIG. 14 is a flowchart illustrating an operation of a first quantization module (e.g., the first quantization module 920 of FIGS. 9 and 11), FIG. 15 is a diagram illustrating positions of solutions of CLSPs in a complex plane, and FIG. 16 is a diagram illustrating positions of solutions of CISPs in the complex plane.

Referring to FIG. 14, according to one embodiment, operations 1410 to 1470 may be sequentially performed but are not limited thereto. For example, two or more operations may be performed in parallel.

In operation 1410, the first quantization module 920 may obtain solutions of complex polynomials (e.g., CLSPs or CISPs) generated by a CLPC analysis module (e.g., the CLPC analysis module 915 of FIGS. 9 and 11).

As shown in FIG. 15, solutions of CLSPs (e.g., P_{c}(Z) and Q_{c}(z) of Equation 7 when λ is 1) may exist on a unit circle in the complex plane. In other words, magnitudes of the solutions of CLSPs may be 1. The solutions of the CLSPs may respectively have properties (e.g., interlaced properties) in which the solutions are alternately positioned on the unit circle. However, each of the solutions of CLSPs may not have a value of −1 or 1, unlike LSPs. This may represent that the CLSPs do not have a critical sampling attribute in which information to be quantized is maintained. When an amount of information to be quantized of LSFs (e.g., phases of solutions of LSPs) is L (e.g., L is a real number), an amount of information to be quantized of CLSFs (e.g., phases of solutions of CSLPs) may be 2L+2.

As shown in FIG. 16, solutions of CISPs (e.g., P_{c}(Z) and Q_{c}(z) of Equation 7 when λ is 0) may exist on a unit circle. In other words, magnitudes of the solutions of CLSPs may be 1. The solutions of the CISPs may respectively have properties (e.g., interlaced properties) in which the solutions are alternately positioned on the unit circle. An amount of information to be quantized of CISFs (e.g., phases of solutions of CISPs) may be 2L+2.

In operation 1420, the first quantization module 920 may obtain phases (e.g., CLSFs or CISFs) of solutions of complex polynomials (e.g., CLSPs or CISPs) between 0 and 2π. Since a magnitude of solutions of the complex polynomials is 1, quantization on the magnitude may not be required.

In operation 1430, the first quantization module 920 may quantize phases (or phase information) (e.g., CLSFs or CISFs) of solutions of complex polynomials (e.g., CLSPs or CISPs). The quantized phases (e.g., quantized CLSFs or quantized CISFs) generated by the first quantization module 920 may be packed as a bitstream by the multiplexer 945 and the bitstream may be transmitted to a decoder (e.g., the decoder 160 of FIGS. 10 and 12).

In operation 1440, the first quantization module 920 may inversely quantize the quantized phases (e.g., the quantized CLSFs or the quantized CISFs) to reconstruct phases (e.g., CLSFs or CISFs) of solutions of complex polynomials (e.g., CLSPs or CISPs).

In operation 1450, the first quantization module 920 may reconstruct solutions (e.g., solutions of P_{c}(z) and Q_{c}(z) of FIGS. 15 and 16) of complex polynomials (e.g., CLSPs or CISPs) by using the reconstructed phases (e.g., the reconstructed phases in operation 1440).

In operation 1460, the first quantization module 920 may reconstruct the complex polynomials (e.g., CLSPs or CISPs) by using the reconstructed solutions (e.g., the reconstructed solutions in operation 1450) of the complex polynomials (e.g., CLSPs or CISPs). The first quantization module 920 may classify the reconstructed solution into an even index or an odd index. The first quantization module 920 may reconstruct one of P_{c}(z) and Q_{c}(z) by using solutions having the even index and may reconstruct the other one of P_{c}(z) and Q_{c}(z) by using solutions having the odd index.

In operation 1470, the first quantization module 920 may reconstruct complex LPCs (or a linear prediction system (e.g., the linear prediction system A_{c}(z) of Equation 6) having complex LPCs as coefficients) by using the reconstructed complex polynomials (e.g., the reconstructed complex polynomials in operation 1460).

The first quantization module 920 may reconstruct complex LPCs (or the linear prediction system A_{c}(z)) based on the reconstructed CLSPs as Equation 8.

$${A}_{c} ( z ) = \frac{{P}_{c} ( z ) + {Q}_{c} ( z )}{2} \qquad [ Equation 8 ]$$

In Equation 8, A_{c}(z) may denote a linear prediction system and P_{c}(z) and Q_{c}(z) may denote reconstructed CLSPs. From a coding perspective, a reconstructed polynomial (or a value) may not be the same as an original polynomial (or a value). However, in the present disclosure, for ease of description, a sign of the reconstructed polynomial may be expressed the same as a sign of the original polynomial.

The first quantization module 920 may reconstruct the linear prediction system A_{c}(z) by using the reconstructed CISPs as Equation 9. Unlike CLSPs, the CISPs may require a last coefficient A_{c} (L) of the linear prediction system A_{c}(z) to reconstruct the linear prediction system A_{c}(z).

$${A}_{c} ( z ) = \frac{1 + \overline{{a}_{c} ( L )}}{2} {P}_{c} ( z ) + \frac{1 - \overline{{a}_{c} ( L )}}{2} {Q}_{c} ( z ) \qquad [ Equation 9 ]$$

As shown in Equation 9, P(z) and Q_{c}(z) may need to be multiplied by

$$\frac{1 + \overline{{a}_{c} ( L )}}{2} and \frac{1 - \overline{{a}_{c} ( L )}}{2} ,$$

respectively, to reconstruct the linear prediction system A_{c}(z) based on CISPs. For this, the encoder 110 may transmit sequence information related to the CISPs to a decoder 1660. The sequence information may include information about a sequence of phases of solutions of P_{c}(z) and Q_{c}(z). For example, the sequence information may include information about P_{c}(z) that P_{c}(z) has a solution of a smallest phase.

FIG. 17 is a diagram illustrating an operation of an inverse quantization module according to one embodiment.

Referring to FIG. 17, according to one embodiment, a first inverse quantization module (e.g., the first inverse quantization module 1015 of FIGS. 10 and 12) may perform operations 1710 to 1740. Operations 1710 to 1740 may be substantially the same as operations 1440 to 1470 described with reference to FIGS. 14 to 16. Accordingly, a repeated description thereof is omitted.

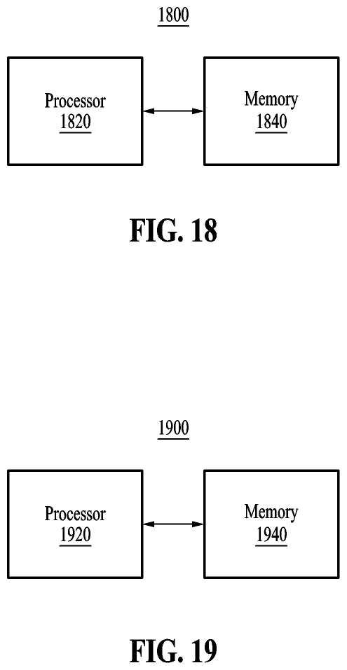

FIG. 18 is a schematic block diagram of an encoder according to one embodiment.

Referring to FIG. 18, according to one embodiment, an encoder 1800 (e.g., the encoder 110 of FIGS. 1, 2, 9, and 11) may include a processor 1820 and a memory 1840.

The memory 1840 may store instructions (or programs) executable by the processor 1820. For example, the instructions include instructions for performing an operation of the processor 1820 and/or an operation of each component of the processor 1820.

The memory 1840 may include one or more of computer-readable storage media. The memory 1840 may include non-volatile storage elements (e.g., a magnetic hard disk, an optical disc, a floppy disc, a flash memory, electrically programmable memory (EPROM), and electrically erasable and programmable memory (EEPROM).

The memory 1840 may be a non-transitory medium. The term “non-transitory” may indicate that the storage medium is not embodied in a carrier wave or a propagated signal. However, the term “non-transitory” should not be interpreted to mean that the memory 1840 is non-movable.

The processor 1820 may process data stored in the memory 1840. The processor 1820 may execute computer-readable code (e.g., software) stored in the memory 1840 and instructions triggered by the processor 1820.

The processor 1820 may be a hardware-implemented data processing device having a circuit that is physically structured to execute desired operations. For example, the desired operations may include code or instructions included in a program.

The hardware-implemented data processing device may include, for example, a microprocessor, a CPU, a processor core, a multi-core processor, a multiprocessor, an ASIC, and an FPGA.

The processor 1820 may cause the encoder 1800 to perform one or more operations by executing the code and/or instructions stored in the memory 1840. The operations performed by the encoder 1800 may be substantially the same as the operations performed by the encoder 110 described above. Accordingly, a repeated description thereof is omitted.

FIG. 19 is a schematic block diagram of a decoder according to one embodiment.

Referring to FIG. 19, according to one embodiment, a decoder 1900 (e.g., the decoder 160 of FIGS. 1, 6, 10, and 12) may include a processor 1920 and a memory 1940.

The memory 1940 may store instructions (or programs) executable by the processor 1920. For example, the instructions include instructions for performing an operation of the processor 1920 and/or an operation of each component of the processor 1920.

The memory 1940 may include one or more of computer-readable storage media. The memory 1940 may include non-volatile storage elements (e.g., a magnetic hard disk, an optical disc, a floppy disc, a flash memory, EPROM, and EEPROM.

The memory 1940 may be a non-transitory medium. The term “non-transitory” may indicate that the storage medium is not embodied in a carrier wave or a propagated signal. However, the term “non-transitory” should not be interpreted to mean that the memory 1940 is non-movable.

The processor 1920 may process data stored in the memory 1940. The processor 1920 may execute computer-readable code (e.g., software) stored in the memory 1940 and instructions triggered by the processor 1920.

The processor 1920 may be a hardware-implemented data processing device having a circuit that is physically structured to execute desired operations. For example, the desired operations may include code or instructions included in a program.

The hardware-implemented data processing device may include, for example, a microprocessor, a CPU, a processor core, a multi-core processor, a multiprocessor, an ASIC, and an FPGA.

The processor 1920 may cause the decoder 1900 to perform one or more operations by executing the code and/or instructions stored in the memory 1940. The operations performed by the decoder 1900 may be substantially the same as the operations performed by the decoder 160 described above. Accordingly, a repeated description thereof is omitted.

The units described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

As described above, although the examples have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Although the disclosure has been illustrated and explained with reference to various embodiments, it will be understood by those skilled in the art that the various embodiments are intended to be illustrative but not restrictive. It will be understood by those skilled in the art that various changes in forms and details may be made without departing from the true spirit and full scope of this disclosure including the scope of the attached claims and their equivalents. Also, it will be understood by those skilled in the art that any of the embodiments described herein may be used in conjunction with other embodiments described herein.

Therefore, other implementations, other examples, and equivalents to the claims are also within the scope of the following claims.

1. A method of decoding an audio signal, the method comprising:
receiving a bitstream comprising information about a first audio signal; and
generating a second audio signal based on first quantization information and a first frequency spectrum obtained from the bitstream,
wherein the first quantization information comprises
quantized complex spectrum frequency information corresponding to the first audio signal, and
the generating of the second audio signal comprises:
obtaining a first complex polynomial, which is a complex spectrum polynomial, based on the quantized complex spectrum frequency information,
restoring complex linear prediction coefficients (LPCs) corresponding to the first audio signal by extracting a coefficient from the first complex polynomial, and
generating the second audio signal based on the first frequency spectrum and restored complex LPCs.

2. The method of claim 1, wherein the quantized complex spectrum frequency information comprises quantization information about solutions of a second complex polynomial and a third complex polynomial, which are generated based on the first complex polynomial.

3. The method of claim 1, wherein the generating of the second audio signal comprises:
filtering the first frequency spectrum based on the first quantization information to generate a second frequency spectrum; and
generating the second audio signal based on the second frequency spectrum.

4. The method of claim 2, wherein magnitudes of solutions of the second complex polynomial and the third complex polynomial are 1.

5. The method of claim 2, wherein the second complex polynomial and the third complex polynomial are generated based on the first complex polynomial and a fourth complex polynomial, and
the fourth complex polynomial is obtained based on a substitution operation on the first complex polynomial and a conjugate complex operation on the first complex polynomial to which the substitution operation is applied.

6. The method of claim 5, wherein the second complex polynomial is generated based on a sum of the first complex polynomial and the fourth complex polynomial, and
the third complex polynomial is generated based on a difference of the first complex polynomial and the fourth complex polynomial.

7. The method of claim 3, wherein the generating of the second audio signal based on the second frequency spectrum comprises:
filtering the second frequency spectrum based on second quantization information obtained from the bitstream; and
converting a filtered second frequency spectrum into a time domain signal to generate the second audio signal,
wherein the second quantization information comprises quantization information about solutions of a fifth complex polynomial and solutions of a sixth complex polynomial, and
the fifth complex polynomial and the sixth complex polynomial are generated based on a seventh complex polynomial having real LPCs corresponding to the first audio signal as coefficients.

8. A method of encoding an audio signal, the method comprising:
generating a first frequency spectrum corresponding to an input audio signal;
generating complex linear prediction coefficients (LPCs) corresponding to the first frequency spectrum;
obtaining complex spectrum frequency information based on a first complex polynomial, which is a complex spectrum polynomial using the complex LPCs as a coefficient; and
generating a bitstream including information obtained by quantizing the first frequency spectrum and the complex spectrum frequency information.

9. The method of claim 8, wherein the generating of the bitstream comprises:
obtaining a second complex polynomial and a third complex polynomial based on the first complex polynomial; and
generating the bitstream based on solutions of the second complex polynomial and the third complex polynomial.

10. The method of claim 9, wherein magnitudes of the second complex polynomial and the third complex polynomial are 1.

11. The method of claim 9, wherein the obtaining of the second complex polynomial and the third complex polynomial based on the first complex polynomial comprises:
obtaining a fourth complex polynomial based on a substitution operation on the first complex polynomial and a conjugate complex operation on the first complex polynomial to which the substitution operation is applied; and
obtaining the second complex polynomial and the third complex polynomial based on the first complex polynomial and the fourth complex polynomial.

12. The method of claim 11, wherein the obtaining of the second complex polynomial and the third complex polynomial based on the first complex polynomial and the fourth complex polynomial comprises:
obtaining the second complex polynomial based on a sum of the first complex polynomial and the fourth complex polynomial; and
obtaining the third complex polynomial based on a difference of the second complex polynomial and the fourth complex polynomial.

13. The method of claim 9, wherein the generating of the bitstream based on the solutions of the second complex polynomial and the third complex polynomial comprises:
reconstructing the complex LPCs based on phases of the solutions of the second complex polynomial and the third complex polynomial;
filtering the first frequency spectrum based on reconstructed complex LPCs; and
generating the bitstream based on a filtered first frequency spectrum.

14. The method of claim 13, wherein the reconstructing of the complex LPCs comprises reconstructing the complex LPCs based on a quantization operation on the phases and an inverse quantization operation on quantized phases.

15. The method of claim 8, wherein the generating of the first frequency spectrum comprises:
generating a second frequency spectrum corresponding to the input audio signal; and
filtering the second frequency spectrum based on real LPCs corresponding to the input audio signal to generate the first frequency spectrum.

16. A device for decoding an audio signal, the device comprising:
a processor; and
a memory configured to store instructions,
wherein, the instructions when executed by the processor, cause the device to perform a plurality of operations, and
the plurality of operations comprises:
receiving a bitstream comprising information about a first audio signal; and
generating a second audio signal based on first quantization information and a first frequency spectrum obtained from the bitstream,
wherein the first quantization information comprises
quantized complex spectrum frequency information corresponding to the first audio signal, and
the generating of the second audio signal comprises:
obtaining a first complex polynomial, which is a complex spectrum polynomial, based on the quantized complex spectrum frequency information,
restoring complex linear prediction coefficients (LPCs) corresponding to the first audio signal by extracting a coefficient from the first complex polynomial, and
generating the second audio signal based on the first frequency spectrum and restored complex LPCs.

17. (canceled)

18. The method of claim 8, wherein the first complex polynomial is a complex line spectral polynomial (CLSP), and
wherein the complex spectrum frequency is a complex line spectral frequency (CLSF).

19. The method of claim 8, wherein the first complex polynomial is a complex immittance spectral polynomial (CISP), and
wherein the complex frequency spectrum frequency information is a complex immittance spectral frequency (CISF).

20. A device for encoding an audio signal, the device comprising:
a processor; and
a memory configured to store instructions,
wherein the instructions, when executed by the processor, cause the device to perform a plurality of operations, and
the plurality of operations comprises:
generating a first frequency spectrum corresponding to an input audio signal;
generating complex linear prediction coefficients (LPCs) corresponding to the first frequency spectrum;
obtaining complex spectrum frequency information based on a first complex polynomial, which is a complex spectrum polynomial using the complex LPCs as a coefficient; and
generating a bitstream including information obtained by quantizing the first frequency spectrum and the complex spectrum frequency information.
